(19) United States
(12) Patent Application Publication
(10) Pub. No.: US 2015/0343322 A1
(43) Pub. Date: Dec. 3, 2015

(54) Novelty self-contained bath tub aerating toy

(71) Applicants: Andrew Morgan Beavers, FEDERAL WAY, WA (US); Travis Charles McKenzie, TACOMA, WA (US)

(72) Inventors: Andrew Morgan Beavers, FEDERAL WAY, WA (US); Travis Charles McKenzie, TACOMA, WA (US)

(21) Appl. No.: 14/729,064

(22) Filed: Jun. 3, 2015

Related U.S. Application Data
(60) Provisional application No. 62/007,370, filed on Jun. 3, 2014.

(51) Int. Cl. A63H 33/28; B01F 15/00; B01F 15/02; B01F 3/04

(52) U.S. Cl. CPC A63H 33/28; B01F 3/04106; B01F 15/00519; B01F 15/0243; B01F 2215/0052

(57) ABSTRACT

A floating apparatus for aerating a fluid having a duck shaped body with a buoyant shell, water sealing removable underside battery tray with water sensing contacts, waterproof inner compartment containing: electronic power and control logic board, gas & liquid pumping system, wherein the pumping system comprises of inlet ports, exhaust ports, inlet tubing, and exhaust tubing. An electrical control logic scheme is an on-off of a pump which is triggered by the status of water sensing contacts.

### BACKGROUND OF THE INVENTION

1. Field of Invention

The invention relates to a self-contained bubble generating apparatus, and more specifically to battery powered aquatic toys using pumps to aerate a fluid to generate bubbles for use in water such as in a bathtub.

2. Prior Art

Toys, which resemble aquatic animals or aquatic vehicles and provide an electronically powered function, are well known. Such toys in the prior art tend to have their functionality limited to simple movement, spitting water, or making entertaining displays of lights and sounds. The toys in the prior art which include functionality for movement through the water do induce some surface effects on the water, but said effects are merely coincidental to the nature of disturbing water.

It is therefore an object of the present invention to provide a self-contained aquatic toy with an electrically powered gas expulsion that aerates the surface of a fluid with micro pockets of gas, for the purpose of dense bubble generation.

It is further an object to provide a gas expulsion system that provides a gentle motive for propulsion as if the accumulation of bubbles is pushing away the body of the present invention.

These objects are attained according to the present invention in a self-contained aquatic toy with an enclosed pump that aerates near the surface of a fluid to generate bubbles on a surface bearing a surfactant while simultaneously providing propelled motion, wherein said device maintains the shape of an aquatic animal or object for the purposes of entertainment.

### SUMMARY OF THE INVENTION

The present invention is a floating apparatus for aerating a fluid having a body with a buoyant shell, water sealing removable underside battery tray with water sensing contacts, waterproof inner compartment containing: electronic power and control logic board, gas & liquid pumping system, wherein the pumping system comprises of inlet ports, exhaust ports, inlet tubing, and exhaust tubing. One example of a buoyant shell is a duck. An example of an electrical control logic scheme is an on-off cycle for the pump triggered by the status of the water sensing contacts.

### BRIEF DESCRIPTION OF THE DRAWINGS

FIG. 1 is a see-through view of complete assembly of invention.

FIG. 2 is an isometric partially exploded view.

FIG. 3 is an isometric view that is further exploded to show all components.

FIG. 4 is an isometric view of the sub-assembly with components housed in 20.

FIG. 5 is an underside view of isolated housing 10.

FIG. 6 is a top, rear near-isometric view, showing the isolated housing 10.

FIG. 7 is a specific alternative embodiment of 10.

FIG. 8 is a specific alternative embodiment of 10.

FIG. 9. is a cross section view of the completely assembled invention taken at exact center of body.

### DETAILED DESCRIPTION

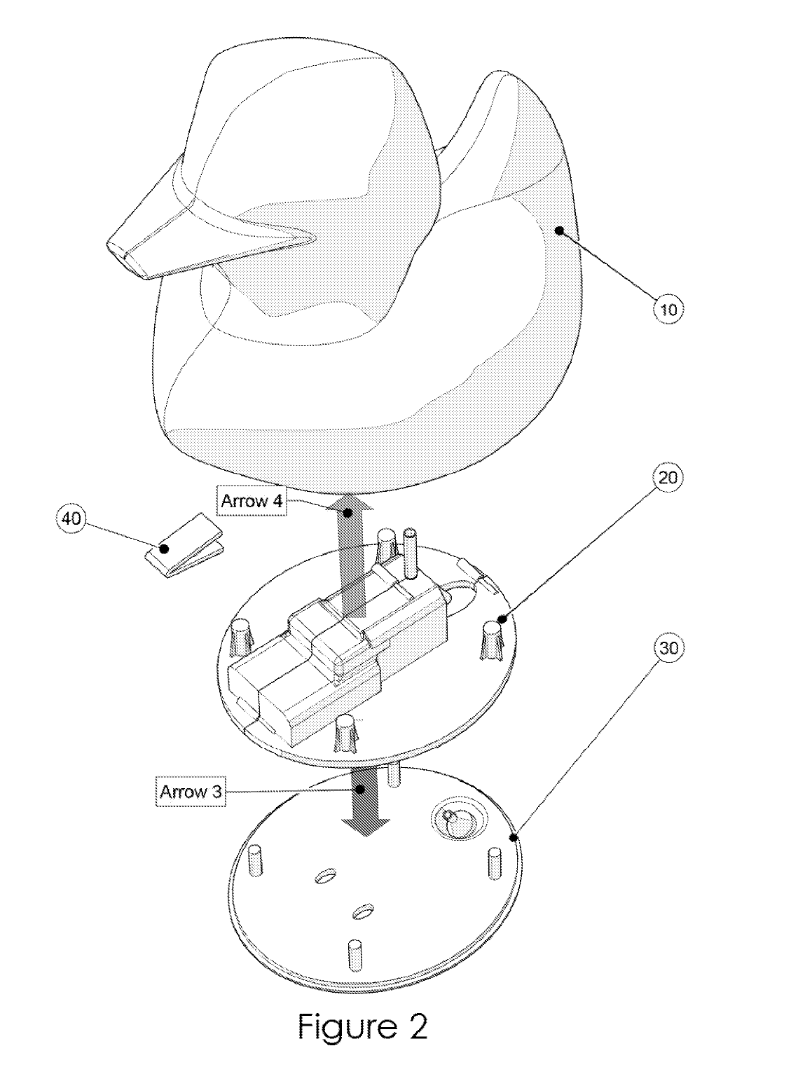

Turning now to the drawings in which like reference characters indicated corresponding elements throughout the several views. The main structure of this embodiment of invention, as shown in FIG. 2, is comprised of the modules: 10, the top of the aesthetic design shell; 20, the carrier component housing the crucial electronic components; 30, the aesthetic design shell bottom with pump discharge outlet; 40, the on/off button.

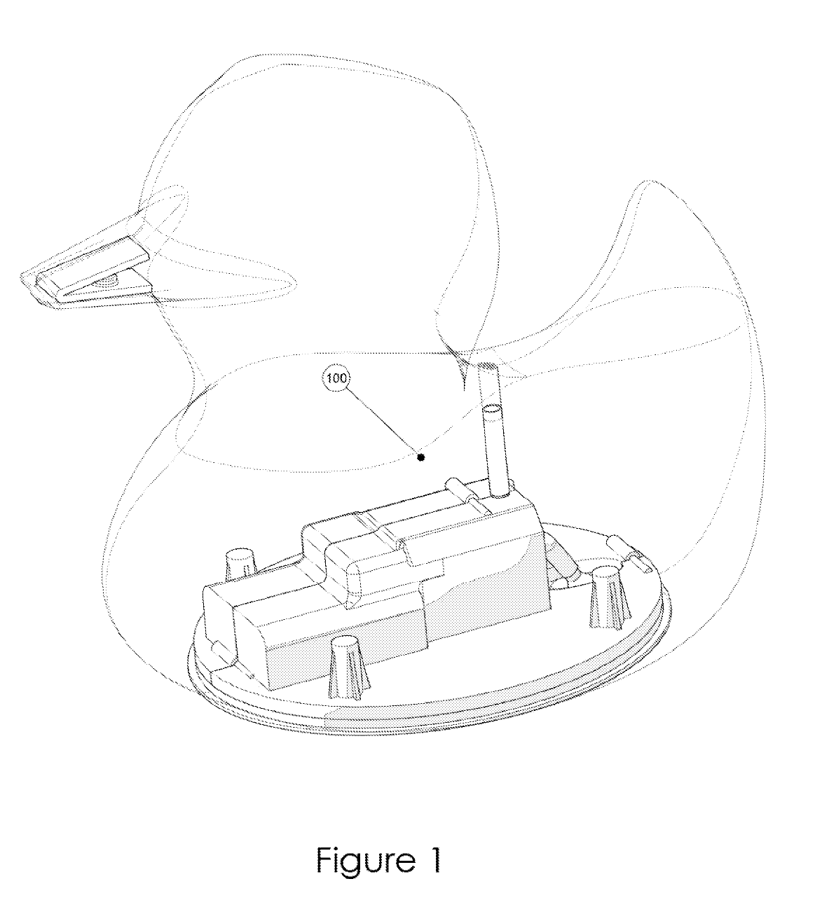

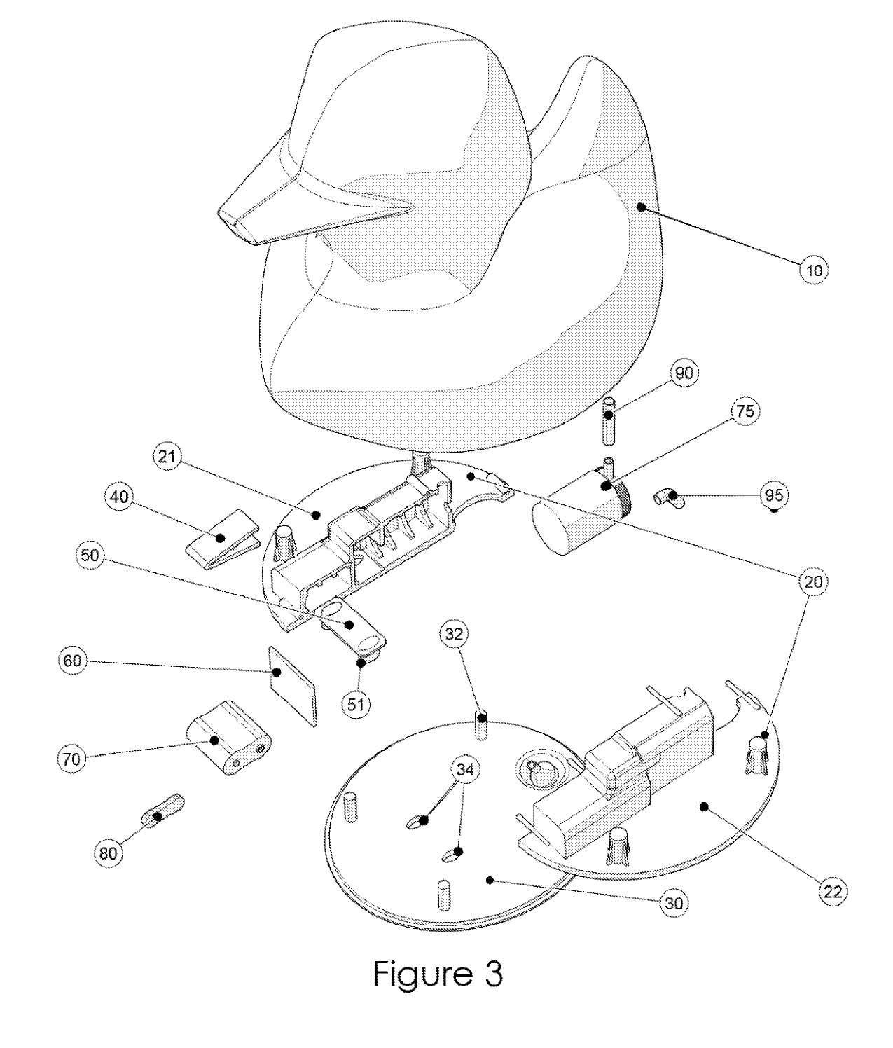

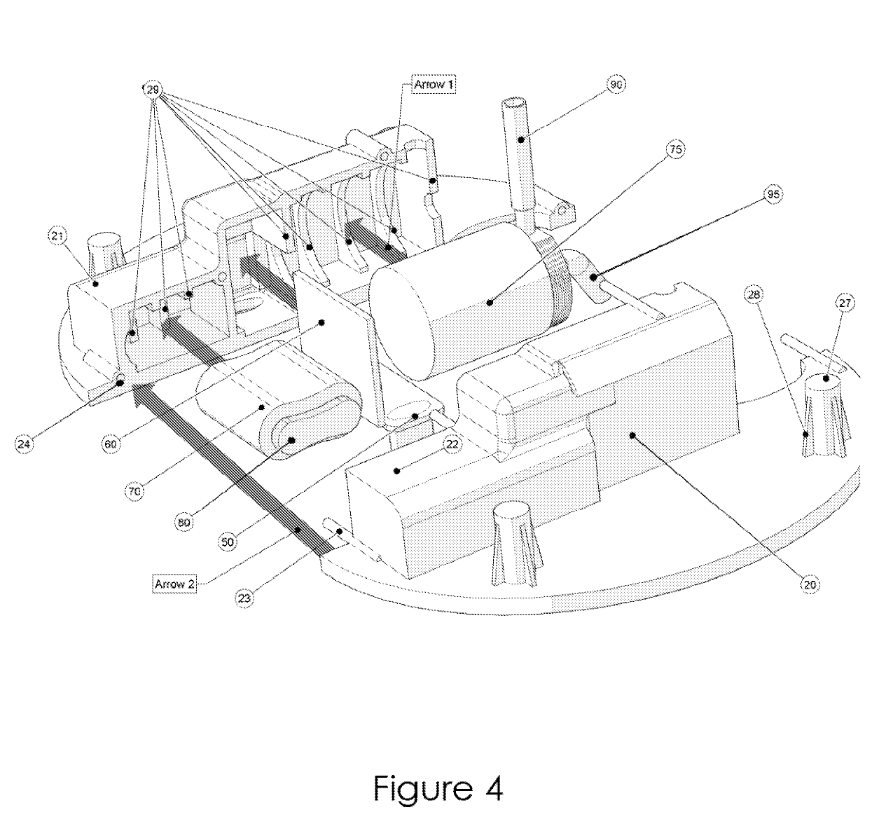

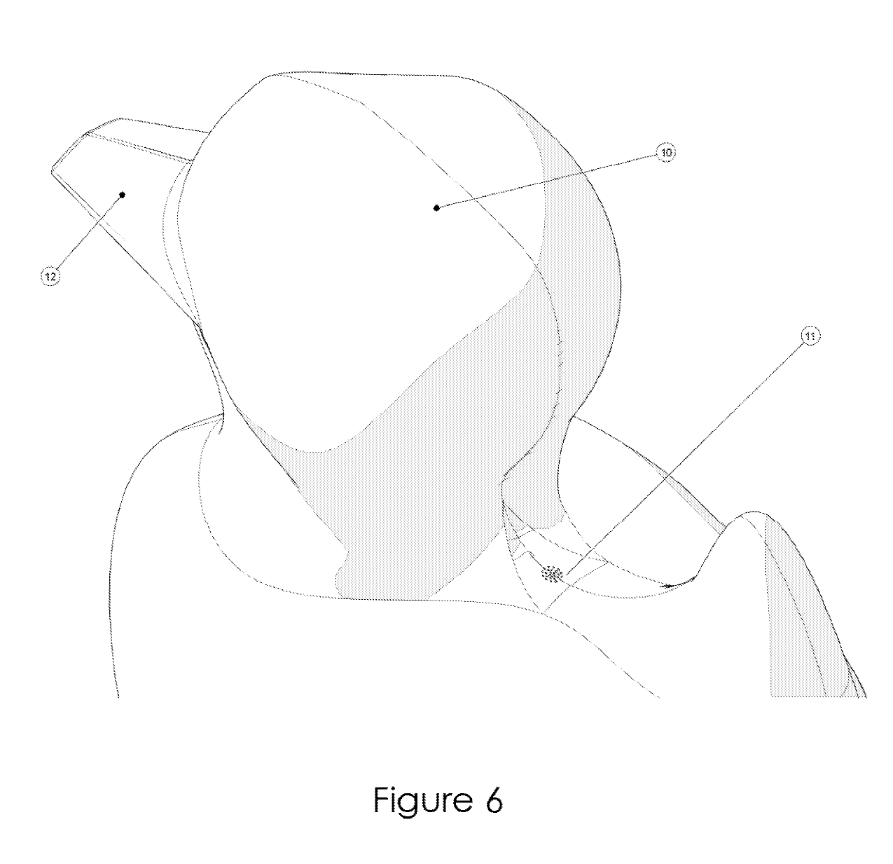

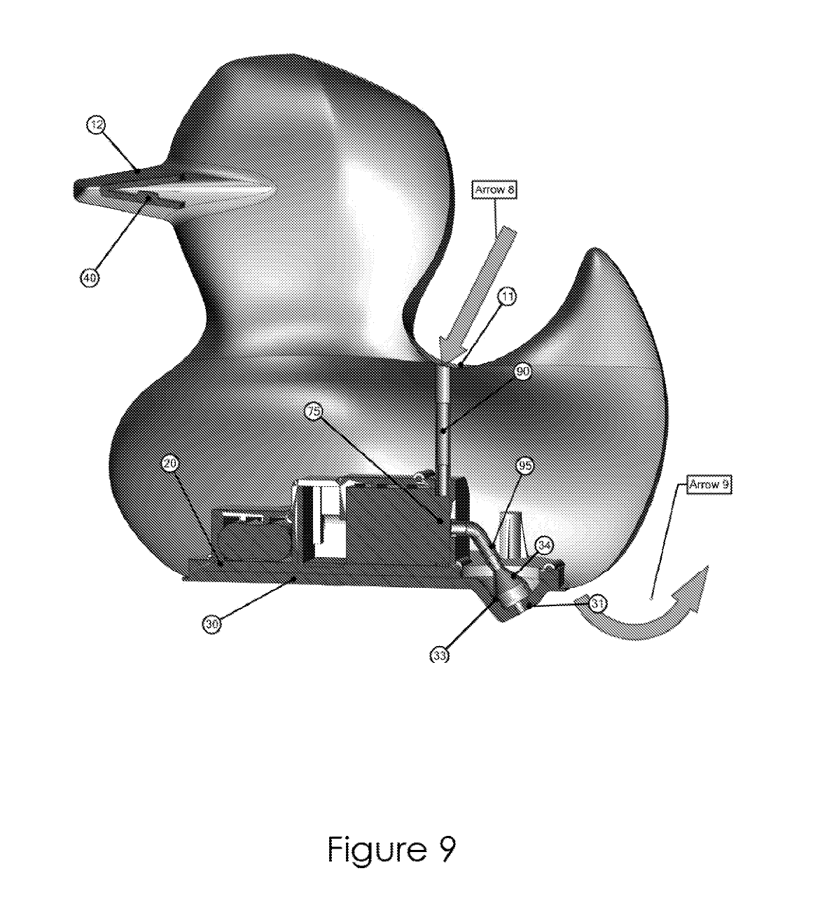

Looking at FIG. 2 the outer shell 10 and bottom shell 30 work, when water tightly fused, to form the aesthetic characteristics of a desired shape. Outer shell 10, can be of a typical construction prevalent in many toy designs being generally made of a soft child safe plastic, one method of manufacture is rotational molding. In this case, the design of bottom shell 30 is such that in assembly the carrier component 20 and it's housed subcomponents, shown in FIG. 3, 50, 60, 70, 75, 80, 90, and 95 are immovably affixed to the bottom shell 30 before the entire sub assembly consisting of 20,30,50, 60, 70, 75, 80, 90, and 95, is immovably affixed to the outer shell 10 forming the final assembled form 100 as shown in FIG. 1; The arrows 1 through 4, shown in FIGS. 2 and 4 , depict this assembly to be taken in the order of the arrow integer designations. This final assembled embodiment of invention leaves a water and air tight final assembly 100 with one point of ingress, 11 in FIG. 6, and one point of egress, 31 in FIG. 9.

Operation of the invention is best illustrated by FIG. 9. Activation of power could be made via an on/off switch 40 actuated via pinching pressure applied to a convenient surface on the outer shell 10, such as the beak of a duck 12. Actuation of switch 40 turns on power to the fluid/gas pump 75, generally of a water and gas capable style, that sucks air from inlet 11 through inner inlet piping 90 to the sealed pump 75 and then accelerates out this air first through inner exhaust piping 95 and then out through nozzle 31 to form bubbles behind the floating aesthetic outer shell 10 in a liquid that has agents capable of forming bubbles. The arrow 8 shows the flow of air into inlet 11 and the arrow 9 shows the flow of exhaust gases out the exhaust nozzle into the area of bubble formation. The flexible exhaust tube 95 is substantially secured and sealed to the exhaust nozzle 34 and 75 in a manner appropriate of a device where water tightness is critical. The flexible inlet tubing 90 is substantially secured and sealed to the inlet nozzle 11 and 75 in a manner appropriate of a device where water tightness is critical.

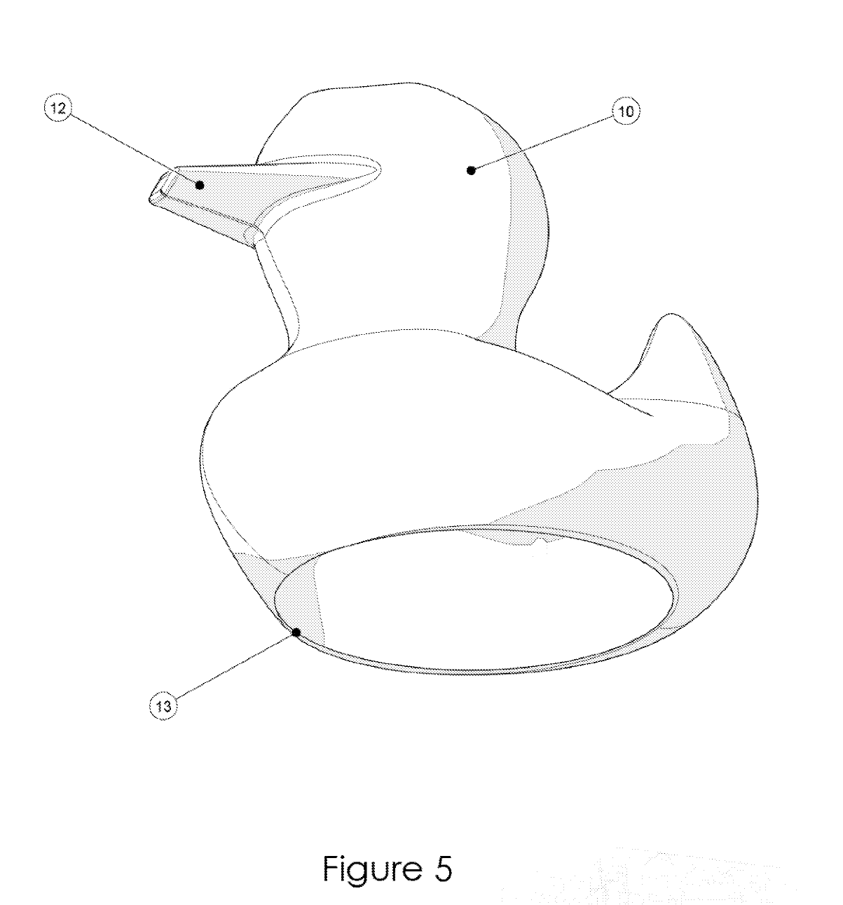

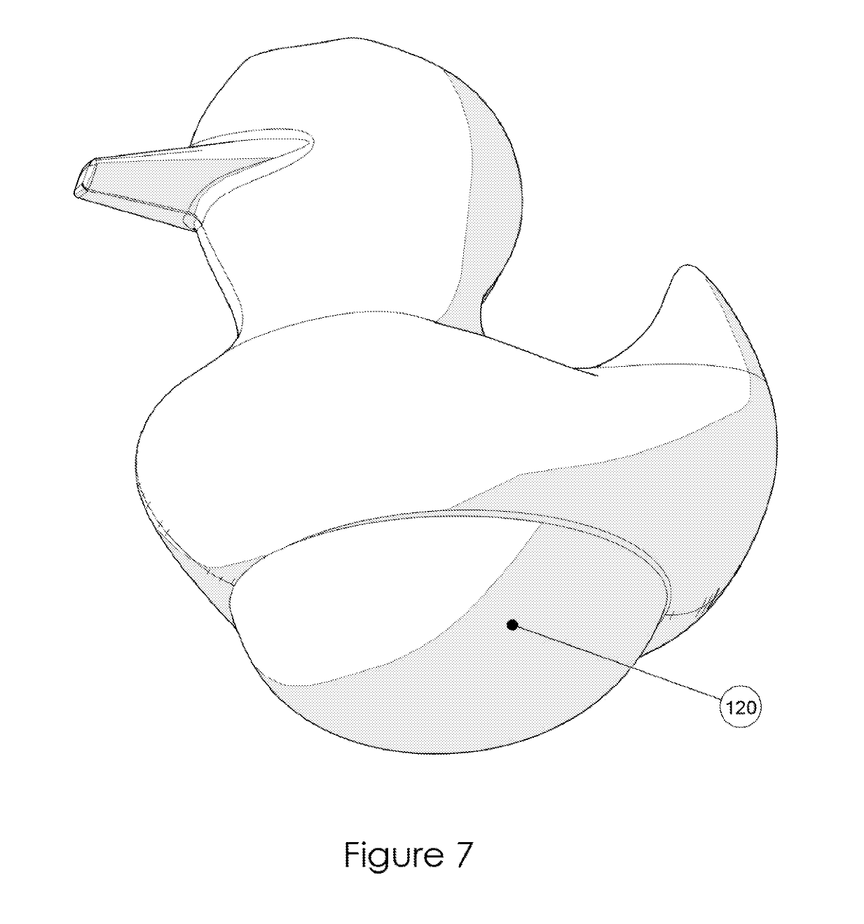

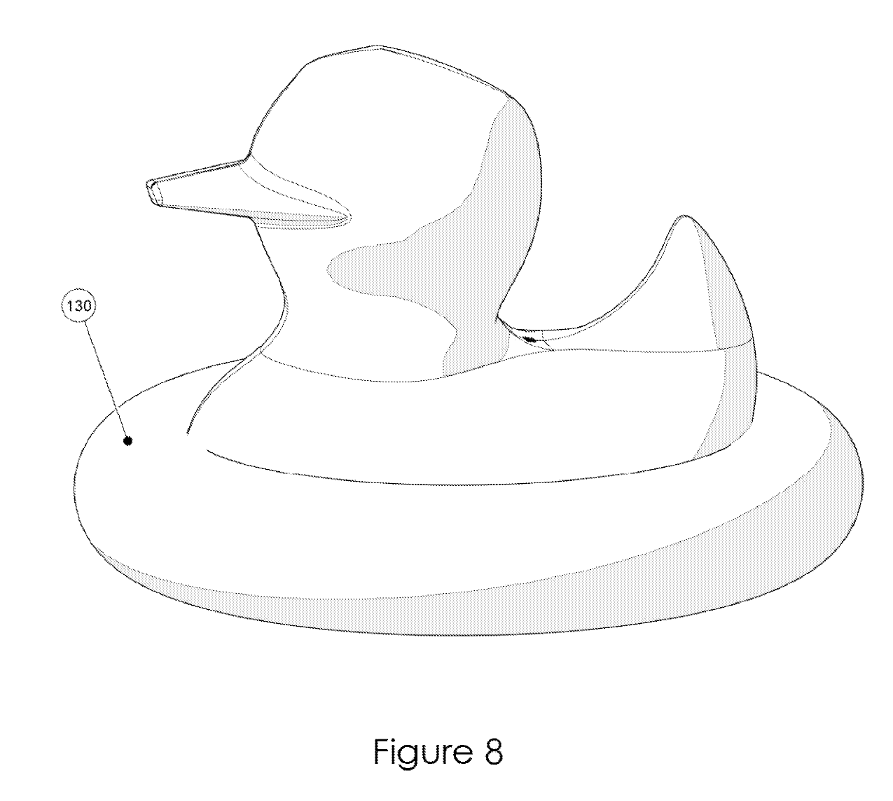

Looking now at FIG. 5 we see an isolated view of the outer shell 10; it is comprised of a thin walled material manufactured in a variety of methods suiting thin walled construction, rotational molding as an example. The design of the outer shell is subject to artistic freedom of a designer but with some restrictions on the feasibility of a shape from an engineering standpoint, mainly that it must be stable and float in a body of water. There generally exists two holes in the outer shell 10; the first being on the top portion 11, best shown in FIG. 6 to allow an inlet of generally low in water mixture of air for said pump 75; the second hole 13 on the bottom portion of the thin walled shell is large enough to allow the entrance of the component carrier 20 and is sealed closed by the bottom shell 30 in assembly. Design alterations to this generally flat bottom structure of the outer shell 10 when combined with the bottom portion of the shell 30 may be made to increase the total volume of water displaced to increase the buoyant force applied to the invention to give more desirable floating and stability effects. A possible design alteration is shown in FIG. 7: a boat like bottom hull 120. The general purpose of these alterations of the invention are to increase the buoyant force on the body by increasing the amount of water displaced with added effect of increased water surface tension area and a lowering of the center of gravity and center of pressure on device into a more stable sub water line position. Likewise a design alteration 130 of outer shell 10 is seen in FIG. 8 showing modification that increases the surface area resting on the top of water for an increase in both buoyant force and surface tension.

Directing attention to FIG. 3 we will now break down the factors of design on the bottom portion of the outer shell 30. The bottom portion of outer shell 30 is a generally thin component matching in thickness and material as the outer shell 10. Any standard plastic manufacturing process is suited for this component; Plastic Injection molding as an example. The generally flat shape of 30 can be adjusted in altered designs when needed for engineering requirements discussed earlier and the alterations to meet this design can be seen in FIGS. 7 and 8. An alternate embodiment of the invention comprises a change in the setup of said battery 70, by making component 34 removably affixed to 10 by a sealed gasket with the addition of a battery tray, thus making a removable battery alternative. The components attached to the outer shell bottom 30 rely on its shape for their general base design and layout and shall be adjusted around the general shape of outer shell bottom 30. These components of whom are children, in design to 30, are generally: the component carrier 20 along with all intricacies, the recharger contact plate 50, and the layout of components 60, 70, 75, 80, 90, and 95. The component 30 contains a number of raised standard bosses 32 that are used to immovably affix the component carrier 20 to the bottom outer shell 30. Attention turning to FIG. 9, a depression 33 from the shape of outer shell bottom 30 of same general wall thickness is typically included to allow a nozzle like form for exhaust gas/fluids to exit away from the body. This depression generally has an inward facing raised boss 34 that connects in a standard male to female type to the outlet tubing 95 coming from the pump 75. The end, or water facing surface of the depression 33 is capped with an outlet nozzle 31 with a number of arranged holes whose size, shape and quantity are allowed to vary to separate the exhaust flow into a certain number of varying size and flow rate bubble streams; the exact design of 31 is generally dependent on the components used in manufacture of this invention and the desired end result in produced bubble density. As shown in FIG. 3, Holes 34 are slotted into 30 to allow for the recharger contact points 51 to pass through the thin walls of the material and make contact with an external recharger. The recharger contact plate 50 consists of two metal contacts 51 in the shape of an external re-charger's terminal points with a thin intermediary body whose shape matches the contours of the bottom outer shell 30. The recharger contact plate is immovably and substantially affixed to the inner portion of 30 with methods of adhesion appropriate in creating a waterproof seal. An alternative embodiment for sending a power signal to said pump 75 comprises a modification of said contacts 51 to be water sensing power cycle triggers.

Turning attention primarily to FIG. 4, immovably fixed in assembly to the bottom Shell is the carrier component sub assembly 20. This component is guided in assembly, arrow 2, to the intended location and affixed via extrude pins 23 on the bottom shell and hollow extrusions 24 on the carrier component 20 located at corner points that insure non movement of the parts when fully assembled. The hollow extrusions 27 are shown in this depiction of invention as having ribs 28 added to better support stresses on the structure and crucially prevent warping from uneven cooling during a plastic injection process, a possible method of manufacture for said carrier component 20. The inside surface of the hollowed extrusion 27 is substantially fixed to the extrusion 32 by means of either friction, a hook and latch system, chemical welding, molecular welding, plastic welding, or other appropriate forms of adhesion. The carrier component 20 is a thin walled plastic device that houses the crucial components of: Vacuum or mixed fluid and gas pump 75, battery 70, battery 70 terminal connector 80, re-charger connector plate 50, PCB board 60 that contains all the necessary electronic components for operation of the invention, inlet pipe 90, and the outlet pipe 95. Electronic connectors to all components are not represented in the three dimensional Figs. Carrier component 20 is split into two halves 21 and 22 for assembly purposes and to allow the component to be manufactured using methods that require drafting and/or split lining. The components within the carrier sub assembly are held in place by various ribs 29 added to the thin shelled walls of 21 and 22 in positions that substantially hold the previously mentioned components within the carrier assembly 20. The halves 21 and 22 of 20 are substantially affixed together with the interface of the cylindrical extrusions 23 and the hollow extrusions 24, whose inner diameter is matched to the outer diameter of feature 23.

The components housed within the carrier component, during the assembly process are generally placed into one side either 21 or 22 of the carrier component 20 and held in the various and appropriately positioned ribs 29 by gravity as long as the half being used for this assembly process is turned up at an appropriate angle, arrow 1 shows this process. The other half can then be attached, immovably securing the components in their holding enclosures created by the ribs 29, arrow 2 shows this process. This assembly is then immovably affixed to the bottom outer shell 30, as shown by arrow 3 in FIG. 2, before being brought into the insides of 10 along arrow 4 where the hole 13, shown in FIG. 5, and the outer edge of 30, shown in FIG. 3, are sealed by a reliable welding or adhesion method including: chemical welding, ultrasonic welding, plastic/simple thermal welding, or by effective means of adhesion.

The above described total embodiment of invention has numerous uses not to be limited to but included: an aquatic toy that floats on a surface and generates bubbles around it. It is to be understood that the foregoing description and specific embodiments are merely illustrative of a specific mode of the invention and the principles thereof, and that various modifications and additions may be made to the apparatus by those skilled in the art, without departing from the spirit and scope of this invention, which is, therefore, understood to be limited only by the scope of the appended claims.

What is claimed is:

1. A novelty self-contained bath tub aerating toy apparatus, said apparatus comprising:
a) a body comprised of an outer shell fused to:
(1) an internal housing compartment.
b) a pump housed in said internal housing compartment that is exhausted below fluid level.
c) an inlet port located above fluid level of said outer shell and inlet piping routed to said pump.
d) an outlet port on said outer shell, located below fluid level, and outlet piping running from said pump.
e) a battery housed within said internal compartment
f) electrical components located inside internal housing compartment

2. The apparatus as claimed in claim 1 further comprising a removable battery tray holding said battery that is joined to said outer shell by a gasket and screw(s) and provides power to components within said internal housing via battery contacts passing through said internal housing's walls.

3. The apparatus as claimed in claim 1 wherein said outlet port is further comprised of an exhaust port with a large multitude of small holes to facilitate large amounts of micro aeration.
